(19) United States
(12) Patent Application Publication
(10) Pub. No.: US 2026/0188566 A1
(43) Pub. Date: Jul. 2, 2026

(54) COIL COMPONENT

(71) Applicant: SAMSUNG ELECTRO-MECHANICS CO., LTD., Suwon-si (KR)

(72) Inventors: Byung Soo KANG, Suwon-si (KR); Jong Woo HAN, Suwon-si (KR); Sang Yup BAEK, Suwon-si (KR); Ji Sook PARK, Suwon-si (KR); Sung Jin BAE, Suwon-si (KR); Kyung Jin HEO, Suwon-si (KR)

(73) Assignee: SAMSUNG ELECTRO-MECHANICS CO., LTD., Suwon-si (KR)

(21) Appl. No.: 19/375,017

(22) Filed: Oct. 30, 2025

(30) Foreign Application Priority Data
Dec. 26, 2024 (KR) 10-2024-0197221

(51) Int. Cl. H01F 27/32; H01F 27/255; H01F 27/29

(52) U.S. Cl. CPC H01F 27/324; H01F 27/255; H01F 27/292

(57) ABSTRACT

A coil component includes a body including a magnetic particle and an insulating film disposed on a surface of the magnetic particle, a coil disposed in the body, and an external electrode disposed on a first surface of the body. The magnetic particle includes a first magnetic particle in direct contact with the external electrode, and a second magnetic particle not in direct contact with the external electrode. At least a portion of the insulating film is in contact with each of the second magnetic particle and the external electrode.

### CROSS-REFERENCE TO RELATED APPLICATION(S)

This application claims benefit of priority to Korean Patent Application No. 10-2024-0197221 filed on Dec. 26, 2024 in the Korean Intellectual Property Office, the disclosure of which is incorporated herein by reference in its entirety.

### TECHNICAL FIELD

The present disclosure relates to a coil component.

An inductor, a coil component, may be a representative passive electronic component used in electronic devices, along with a resistor and a capacitor.

In a coil component having an electrode structure on a lower surface thereof, copper (Cu) plating may be formed on a lower surface of a body using an electrochemical method. When powder is exposed on the lower surface of the body, adhesion to a seed layer may be weakened due to an insulating coating layer on the powder. As a result, issues such as poor plating of an external electrode may occur.

### SUMMARY

An aspect of the present disclosure is to provide a coil component having improved adhesion between a body and an external electrode.

Another aspect of the present disclosure is to provide a coil component having improved withstand voltage properties.

According to an aspect of the present disclosure, there is provided a coil component including a body including a magnetic particle and an insulating film disposed on a surface of the magnetic particle, a coil disposed in the body, and an external electrode disposed on a first surface of the body. The magnetic particle may include a first magnetic particle in direct contact with the external electrode, and a second magnetic particle is free of direct contact with the external electrode. At least a portion of the insulating film may be in contact with the second magnetic particle and the external electrode.

According to example embodiments of the present disclosure, adhesion between a body and an external electrode of a coil component may be improved.

According to example embodiments of the present disclosure, a coil component may have improved withstand voltage properties.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a coil component according to an example embodiment of the present disclosure;

FIG. 2 is a cross-sectional view taken along line I-I′ of FIG. 1;

FIG. 3 is a cross-sectional view taken along line II-II′ of FIG. 1;

FIG. 4 is an enlarged view of portion “A” of FIG. 3;

FIG. 5 is an enlarged view of portion “B” of FIG. 3; and

FIG. 6 is a bottom view of the coil component of FIG. 1.

### DETAILED DESCRIPTION

The terms used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this code, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not limited to those illustrated herein.

In the drawings, an X-direction may be defined as a first direction or a thickness direction, a Y-direction may be defined as a second direction or a length direction, and a Z-direction may be defined as a third direction or a width direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

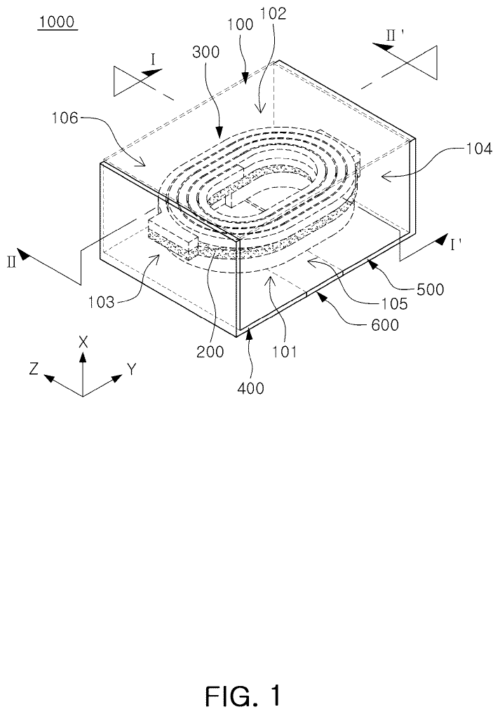

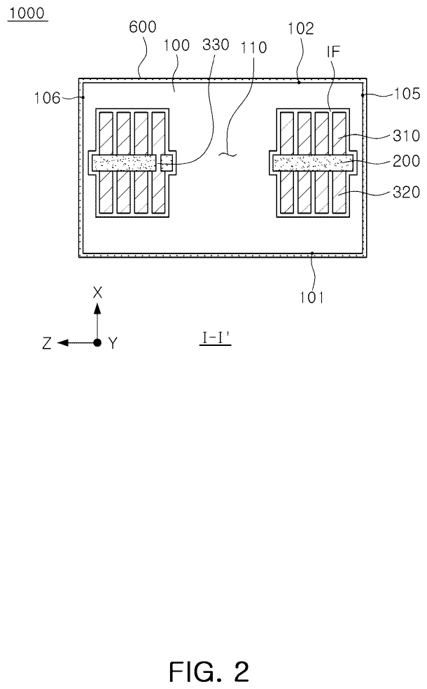

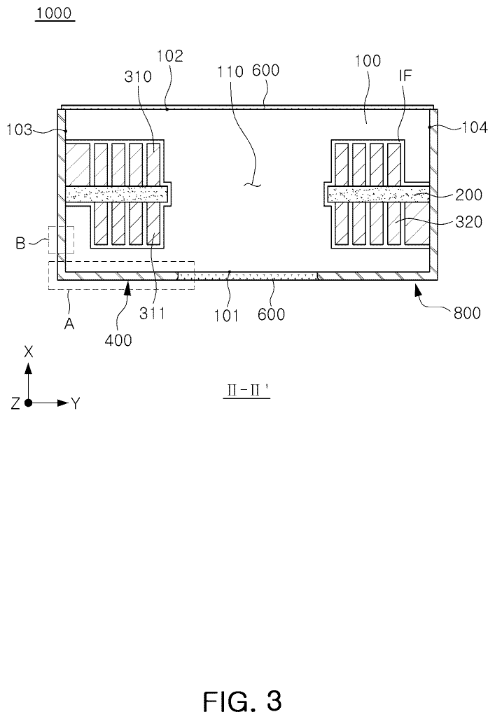

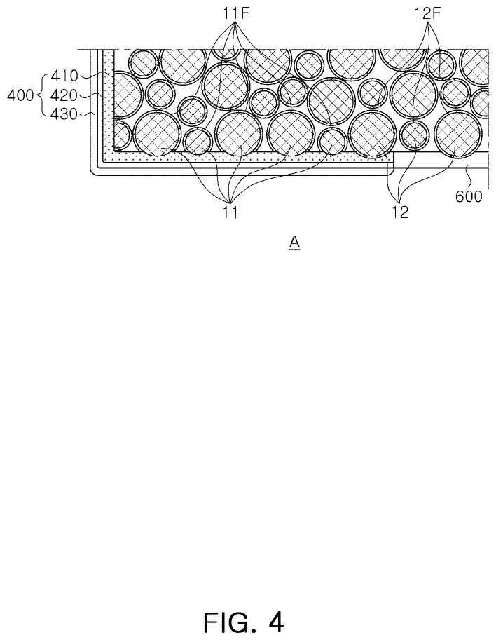

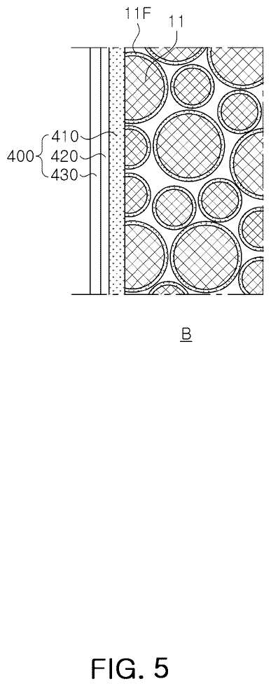

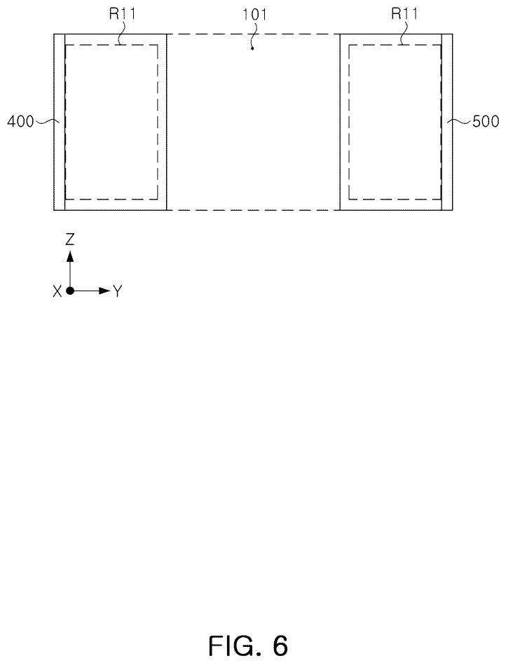

FIG. 1 is a schematic perspective view of a coil component according to an example embodiment of the present disclosure. FIG. 2 is a cross-sectional view taken along line I-I′ of FIG. 1. FIG. 3 is a cross-sectional view taken along line II-II′ of FIG. 1. FIG. 4 is an enlarged view of portion “A” of FIG. 3. FIG. 5 is an enlarged view of portion “B” of FIG. 3. FIG. 6 is a bottom view of the coil component of FIG. 1.

Referring to FIGS. 1 to 6, a coil component 1000 according to an example embodiment of the present disclosure may include a body 100, a support member 200, a coil 300, external electrodes 400 and 500, and an insulating layer 600, and may further include a coil insulating film IF.

The body 100 may form an exterior of the coil component 1000 according to the present example embodiment, and the coil 300 and the support member 200 may be disposed in the body 100.

The body 100 may have an overall hexahedral shape.

In the directions of FIGS. 1 to 3, the body 100 may have a first surface 101 and a second surface 102 opposing each other in a first direction (X-direction), a third surface 103 and a fourth surface 104 opposing each other in a second direction (Y-direction), and a fifth surface 105 and a sixth surface 106 opposing each other in a third direction (Z-direction). The third to sixth surfaces 103, 104, 105, and 106 of the body 100 may be respectively side surfaces of the body 100, connecting the first surface 101 and the second surface 102 of the body 100 to each other. Hereinafter, the first surface 101 of the body 100 may refer to a lower surface of the body, but the present disclosure is not limited thereto.

For example, the body 100 may be formed such that the coil component 1000 according to the present example embodiment, including the external electrodes 400 and 500 and the insulating layer 600 to be described below, has a length of 2.0 mm, a width of 1.2 mm, and a thickness of 0.65 mm, but the present disclosure is not limited thereto. The above-described numerical values are merely design values not reflecting a process error or the like, such that it should be considered that dimensions within a range admitted as a processor error fall within the scope of the present disclosure.

The body 100 may include a core 110 passing through the support member 200 and the coil 300 to be described below. The core 110 may be formed by filling a through-hole, passing through a central portion of each of the coil 300 and the support member 200, with a magnetic composite sheet, but the present disclosure is not limited thereto.

The body 100 may include magnetic particles 11 and 12 and insulating films 11F and 12F disposed on surfaces of the magnetic particles 11 and 12.

The magnetic particles 11 and 12 may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic particles 11 and 12 may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, or Fe—Cr—Al-based alloy powder particles.

The magnetic particles 11 and 12 may be amorphous or crystalline. For example, the magnetic particles 11 and 12 may be Fe—Si—B—Cr-based amorphous alloy powder particles, but the present disclosure is not limited thereto. The magnetic particles 11 and 12 may have an average diameter of about 0.1 μm to about 30 μm, but the present disclosure is not limited thereto.

The magnetic particles 11 and 12 may include two or more types of magnetic particles. Here, different types of magnetic particles may mean that magnetic particles dispersed in a resin are distinguished from each other in terms of one of an average diameter, a composition, crystallinity, and a shape. For example, as illustrated in FIG. 4, the magnetic particles 11 and 12 may include multiple magnetic particles having different particle diameters.

The insulating films 11F and 12F may be formed on surfaces of the magnetic particles 11 and 12. The insulating films 11F and 12F may include, for example, epoxy, polyimide, a liquid crystal polymer, or the like, alone or in combination, may include silica (SiO₂) or alumina (Al₂O₃), or may be oxide films of a metal, wherein the metal may be one that is present in the magnetic particles.

The body 100 may include a resin. The body 100 may have magnetic particles 11 and 12 dispersed in the resin. The resin may be an element distinguished from the insulating films 11F and 12F formed on the surfaces of the magnetic particles. The body according to the present example embodiment may be formed by laminating one or more magnetic composite sheets including a resin and the magnetic particles 11 and 12 dispersed in the resin.

The resin may include epoxy, polyimide, a liquid crystal polymer, or the like alone or in combination, but the present disclosure is not limited thereto.

Referring to FIG. 4, the magnetic particles 11 and 12 may include a first magnetic particle 11 in direct contact with an external electrode to be described below, and a second magnetic particle 12 not in direct contact with the external electrode.

The first magnetic particle 11 may extend to the first surface 101 of the body 100. In this case, a portion of the first magnetic particle 11 may further protrude than the first surface 101. The insulating film 11F may not be disposed on the protruding portion of the first magnetic particle 11. That is, the insulating film 11F may not be disposed on a portion of the surface of the first magnetic particle 11, such that the first magnetic particle 11 may be in direct contact with the external electrodes 400 and 500.

In a coil component having an electrode structure on a lower surface thereof, copper (Cu) plating may be formed on a lower surface of a body using an electrochemical method. When powder is exposed on the lower surface of the body, adhesion to a seed layer may be weakened due to an insulating coating layer on the powder. As a result, issues such as poor plating of an external electrode may occur.

In the coil component 1000 according to the present example embodiment, the insulating film 11F on the surface of the first magnetic particle 11 exposed to the first surface 101 of the body may be partially removed, and a plating layer of each of the external electrodes 400 and 500 may be directly formed on the surface of the first magnetic particle 11. That is, the first magnetic particle 11 may serve as a seed during plating of the external electrodes 400 and 500. The surface of the first magnetic particle 11 from which the insulating film 11F is removed may have surface roughness, such that the external electrodes may be stably formed on the first surface 101 of the body.

The first magnetic particle 11, extending to the first surface 101 of the body, may have a circular or elliptical cross-section. In contrast, the first magnetic particle 11, extending to the third surface 103 and the fourth surface 104 of the body, may have a cut surface, as will be described below. The first surface 101 of the body may be a lower surface of the coil component 1000 according to the present example embodiment, and a dicing process may not be performed on the lower surface. Accordingly, when observed in a cross-sectional sample, the first magnetic particle 11, extending to the first surface 101 of the body, may maintain a curved outline, and may have a complete circular or elliptical cross-section. In addition, as illustrated in FIG. 4, at least a portion of the first magnetic particle 11, extending to the first surface 101, may protrude from the first surface 101 while maintaining a circular or elliptical shape.

Only a portion of the insulating film 11F of the first magnetic particle 11 may be removed. Referring to FIG. 4, the insulating film 11F may remain on a surface of the first magnetic particle 11 that is not exposed to the first surface 101.

FIG. 6 is a bottom view of the coil component of FIG. 1. For ease of description, the insulating layer 600 is omitted in FIG. 6.

Referring to FIG. 6, a region R11 in which the first magnetic particle 11 is distributed on the first surface 101 of the body may be narrower than a region in which the external electrodes 400 and 500 are disposed on the first surface 101. Specifically, as illustrated in FIG. 6, the region R11 may have a length in a Y-direction (second direction) and a length in a Z-direction (third direction) less than those of the region in which the external electrodes 400 and 500 are disposed. The lengths may be measured by a microscope (e.g., optical microscope or electron microscope). Other methods and/or tools appreciated by one of ordinary skill in the art, even if not described in the present disclosure, may also be used.

When the insulating films of the magnetic particles are removed in the entire region in which the external electrodes 400 and 500 are disposed, the coil component may have degraded withstand voltage properties. Accordingly, the insulating film 11F may be removed only from some magnetic particles 11 in the region in which the external electrodes 400 and 500 are disposed, thereby improving the withstand voltage properties.

At least a portion of the first magnetic particle 11 may extend to the third surface 103 and the fourth surface 104 of the body 100, and may be in contact with the first and second external electrodes 400 and 500. The first magnetic particle 11, extending to the third surface 103 and the fourth surface 104 of the body 100, may have a cut surface. The third surface 103 and the fourth surface 104 of the body 100 may be dicing surfaces of the coil component. In general, in a thin-film coil component, a coil bar in which a plurality of coils and a plurality of bodies are connected to each other may be formed on a large-area substrate, and dicing is performed in the second direction (Y-direction) and third direction (Z-direction) to individualize bodies of a plurality of components. Accordingly, the magnetic particle 11, extending to the third surface 103 and the fourth surface 104 of the body 100 of the coil component according to the present example embodiment, may have a cut surface. The insulating film 11F may also be removed during the dicing process, such that the insulating film may not be disposed on the cut surface of the magnetic particle 11. In addition, the cut surfaces may be coplanar with the third surface 103 and the fourth surface 104 of the body, and the magnetic particle 11 may not protrude from the third surface 103 and the fourth surface 104.

At least a portion of the second magnetic particle 12 may extend to the first surface 101 of the body 100. In this case, a portion of the second magnetic particle 12 may protrude from the first surface 101. However, unlike the first magnetic particle 11 described above, the insulating film 12F of the second magnetic particle 12, extending to the first surface 101, may not be removed. Accordingly, the second magnetic particle 12 may have the following positional relationship with the external electrodes 400 and 500 or the insulating layer 600.

At least a portion of the second magnetic particle 12 may have the insulating film 12F in contact with the external electrodes 400 and 500. Referring to FIG. 4, at least a portion of the insulating film 12F is in contact with each of the second magnetic particle 12 and the external electrode 400. As described above, since the insulating film 12F is not removed from the remaining magnetic particles 12 except for some magnetic particles 11 in the region where the external electrodes 400 and 500 are disposed, the breakdown voltage characteristic may be improved. Accordingly, the second magnetic particle 12 may be disposed outside the body 100 in the second direction (Y-direction) with respect to the insulating layer 600 to be described later. Referring to FIG. 4, some of the second magnetic particle 12 are located outside the body 100 with respect to the boundary between the insulating layer 600 and the external electrode 400. Also, referring to FIG. 6, the second magnetic particle 12 may be distributed in the remaining region of the first surface 101 of the body 100 other than the region R11. Therefore, at least a portion of the second magnetic particle 12 may be distributed in the region in which the external electrodes 400 and 500 are disposed on the first surface 101.

At least a portion of the second magnetic particle 12 may have the insulating film 12F that is in contact with the insulating layer 600. That is, at least a portion of the insulating film 12F may be disposed between the second magnetic particle 12 and the insulating layer 600.

The support member 200 may be buried in the body 100. The support member 200 may be configured to support the coil 300 to be described below.

The support member 200 may be formed of an insulating material including a thermosetting insulating resin such as an epoxy resin, a thermoplastic insulating resin such as polyimide, or a photosensitive insulating resin, or an insulating material in which a reinforcing material, such as a glass fiber or an inorganic filler, is impregnated into above-described insulating resins. For example, the support member 200 may be formed of an insulating material such as a prepreg, an Ajinomoto build-up film (ABF), FR-4, a bismaleimide triazine (BT) resin, a photoimageable dielectric (PID), or the like, but the present disclosure is not limited thereto.

At least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used as the inorganic filler.

When the support member 200 is formed of an insulating material including a reinforcing material, the support member 200 may provide more excellent rigidity. When the support member 200 is formed of an insulating material not including a glass fiber, it may be advantageous in reducing a thickness of the coil component 1000 according to the present example embodiment. In addition, when the body 100 has the same size, a volume occupied by the coil 300 and/or the magnetic particles 11 and 12 may be increased, which may lead to improved component properties. When the support member 200 is formed of an insulating material including a photosensitive insulating resin, the number of processes for forming the coil 300 may be reduced, which may be advantageous in reducing production costs, and a fine via may be formed.

The coil 300 may be disposed in the support member 200 to exhibit properties of the coil component. For example, when the coil component 1000 according to the present example embodiment is used as a power inductor, the coil 300 may serve to stabilize power of an electronic device by storing an electric field as a magnetic field and maintaining an output voltage.

The coil 300 may include coil patterns 310 and 320 and a via 330. Specifically, in the directions of FIGS. 1 to 3, a first coil pattern 310 may be disposed on an upper surface of the support member 200 opposing the second surface 102 of the body 100, and a second coil pattern 320 may be disposed on a lower surface of the support member 200 opposing the upper surface of the support member 200. The via 330 may pass through the support member 200 and connect the first coil pattern 310 and the second coil pattern 320 to each other. Thus, the coil 300 may serve as a single coil between the first and second external electrodes 400 and 500.

Each of the first coil pattern 310 and the second coil pattern 320 may have a planar spiral shape in which at least one turn is formed using the core 110 as an axis. For example, in the directions of FIGS. 1 and 2, the first coil pattern 310 may form a plurality of turns on the upper surface of the support member 200, using the core 110 as an axis. The second coil pattern 320 may form a plurality of turns on the lower surface of the support member 200, using the core 110 as an axis.

One end of the first coil pattern 310 may extend to the third surface 103 of the body, and may be connected to the first external electrode 400 to be described below, and the other end of the first coil pattern 310 may be connected to the via 330. One end of the second coil pattern 320 may extend to the fourth surface 104 of the body, and may be connected to the second external electrode 500 to be described below, and the other end of the second coil pattern 320 may be connected to the via 330.

At least one of the coil patterns 310 and 320 and the via 330 may include at least one conductive layer.

For example, when the first coil pattern 310 and the via 330 are formed by plating, each of the first coil pattern 310 and the via 330 may include a seed layer formed by vapor deposition such as electroless plating or sputtering, and an electrolytic plating layer. Here, the electrolytic plating layer may have a single-layer structure or a multilayer structure. The electroplating layer having a multilayer structure may be formed in a conformal film structure in which one electroplating layer covers another electroplating layer, or may be formed in a shape in which one electroplating layer is laminated only on one surface of another electroplating layer. The seed layers of the first coil pattern 310 and the via 330 may be integrally formed, such that boundaries therebetween may not be formed, but the present disclosure is not limited thereto. The electrolytic plating layers of the first coil pattern 310 and the via 330 may also be integrally formed, such that boundaries therebetween may not be formed, but the present disclosure is not limited thereto.

Each of the coil patterns 310 and 320 and the via 330 may be formed of a conductive material such as copper (Cu), aluminum (Al), silver (Ag), tin (Sn), gold (Au), nickel (Ni), lead (Pb), titanium (Ti), molybdenum (Mo), or alloys thereof, but the present disclosure is not limited thereto.

The external electrodes 400 and 500 may be disposed on the first surface 101 of the body 100. The first surface 101 of the body 100 may be a lower surface, such that the coil component according to the present example embodiment may be a coil component having an electrode structure on a lower surface thereof.

The external electrodes 400 and 500 may include a first external electrode 400 disposed on the first surface 101 and the third surface 103 of the body 100, and a second external electrode 500 disposed on the first surface 101 and the fourth surface 104 of the body 100.

The first external electrode 400 may be disposed on the third surface 103 of the body 100, and may be connected to one end of the first coil pattern 310. The second external electrode 500 may be disposed on the fourth surface 104 of the body 100, and may be connected to one end of the second coil pattern 320. The first and second external electrodes 400 and 500 may be disposed on the first surface 101 of the body 100 to be spaced apart from each other by an insulating layer 600.

Referring to FIG. 4, the external electrode 400 may be disposed inward of the body in a second direction (Y-direction) relative to the first magnetic particle 11. As described above, in the coil component according to the present example embodiment, the insulating film 11F may be selectively removed only from some magnetic particles 11 in the region in which the external electrodes 400 and 500 are disposed. The first magnetic particle 11, from which the insulating film 11F is removed, may be disposed outward of the body relative to a boundary between the external electrode 400 and the insulating layer 600.

The external electrodes 400 and 500 may include first layers 410 and 510 and second layers 420 and 520 disposed on the first layers. That is, the external electrodes may have a multilayer structure. For example, the first external electrode 400 may include a first layer 410 including copper (Cu), a second layer 420 disposed on the first layer, the second layer 420 including nickel (Ni), and a third layer 430 disposed on the second layer, the third layer including tin (Sn). Here, each of the first to third layers may be formed by plating, but the present disclosure is not limited thereto.

The first layers 410 and 510 of the external electrodes may include copper (Cu). The first layers 410 and 510 of the external electrodes may be in direct contact with the first magnetic particle 11. During plating of the first layer 410 or 510, the first magnetic particle 11 may serve as a seed. The insulating film 11F may be partially removed from the first magnetic particle 11, and the first magnetic particle 11 may be in direct contact with the first layers 410 and 510 of the external electrodes, such that the first layers 410 and 510 may be stably formed on the first surface 101 of the body.

However, the present disclosure is not limited thereto. For example, the first layers 410 and 510 of the external electrodes may be conductive resin layers. The conductive resin layer may include a resin and metal components dispersed in the resin. The resin, a thermosetting resin, may include epoxy. The metal components may include silver (Ag) or copper (Cu). For example, in the present example embodiment, the conductive resin layer may be an Ag epoxy layer or a Cu epoxy layer.

The first and second external electrodes 400 and 500 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

The external electrodes 400 and 500 may be formed using a vapor deposition method such as sputtering and/or a plating method, but the present disclosure is not limited thereto.

The insulating layer 600 may be disposed on the first surface 101 of the body 100, and may cover side surfaces of the external electrodes 400 and 500.

The insulating layer 600 may be disposed on a surface of the body 100 to prevent the body 100 from being exposed to the outside of the coil component. Specifically, the insulating layer 600 may be disposed on regions of the first surface 101, the second surface 102, the fifth surface 105, and the sixth surface 106 of the body 100 in which the external electrodes are not formed. The insulating layer 600 may serve as a plating resist when the external electrodes 400 and 500 are formed by plating, but the present disclosure is not limited thereto.

The insulating layer 600 may be disposed on the surface of the body 100 on which the external electrodes 400 and 500 are not formed, and may serve to electrically protect the coil component, reduce leakage current, and prevent plating spread during formation of the external electrodes.

The insulating layer 600 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOₓ or SiNₓ.

The coil insulating film IF may be disposed between the coil 300 and the body 100 and between the support member 200 and the body 100. The coil insulating film IF may be formed along a surface of the support member 200, but the present disclosure is not limited thereto. The coil insulating film IF may be used to insulate the coil 300 and the body 100 from each other, and may include a known insulating material such as parylene or the like, but the present disclosure is not limited thereto. As another example, the coil insulating film IF may include an insulating material such as an epoxy resin or the like, rather than parylene. The insulating film IF may be formed using a vapor deposition method, but the present disclosure is not limited thereto. As another example, the coil insulating film IF may be formed by laminating and curing an insulating film for forming the coil insulating film IF on both surfaces of the support member 200 on which the coil 300 is formed, and the coil insulating film IF may be formed by coating and curing an insulating paste for forming the coil insulating film IF on both surfaces of the support member 200 on which the coil 300 is formed. For the reasons described above, the coil insulating film IF may be omitted in the present example embodiment. That is, when the body 100 has sufficient electrical resistance at a designed operating current and voltage of the coil component 1000 according to the present example embodiment, the coil insulating film IF may be omitted in the present example embodiment.

While example embodiments have been shown and described above, it will be apparent to those skilled in the art that modifications and variations could be made without departing from the scope of the present disclosure as defined by the appended claims.

What is claimed is:

1. A coil component comprising:
a body including a magnetic particle and an insulating film disposed on a surface of the magnetic particle;
a coil disposed in the body; and
an external electrode disposed on a first surface of the body,
wherein the magnetic particle includes a first magnetic particle in direct contact with the external electrode, and a second magnetic particle is free of direct contact with the external electrode, and
at least a portion of the insulating film is in contact with the second magnetic particle and the external electrode.

2. The coil component of claim 1, wherein the first magnetic particle extends to the first surface of the body, and the insulating film is not disposed on at least a portion of a surface of the first magnetic particle.

3. The coil component of claim 1, wherein at least a portion of the first magnetic particle protrudes from the first surface of the body.

4. The coil component of claim 1, wherein the body has a first surface and a second surface opposing the first surface in a first direction, and a third surface and a fourth surface connecting the first surface and the second surface to each other, the third surface and the fourth surface opposing each other in a second direction.

5. The coil component of claim 4, wherein the external electrode is disposed inward of the body relative to the first magnetic particle in the second direction.

6. The coil component of claim 4, further comprising:
an insulating layer disposed on the first surface of the body, the insulating layer covering a side surface of the external electrode.

7. The coil component of claim 6, wherein the second magnetic particle is disposed outside of the body relative to the insulating layer in the second direction.

8. The coil component of claim 6, wherein at least a portion of the insulating film is disposed between the second magnetic particle and the insulating layer.

9. The coil component of claim 4, wherein the external electrode includes a first external electrode disposed on the third surface and the first surface of the body, and a second external electrode disposed on the fourth surface and the first surface of the body.

10. The coil component of claim 9, wherein
at least a portion of the first magnetic particle extends to the third surface and the fourth surface of the body, and
the first magnetic particle extended to the third surface and the fourth surface of the body has a cut surface.

11. The coil component of claim 1, wherein
the external electrode includes a first layer and a second layer disposed on the first layer, and
the first layer includes at least one selected from the group consisting of copper (Cu) and silver (Ag).

12. The coil component of claim 11, wherein the first layer further includes a resin.

13. A coil component comprising:
a body including a magnetic particle and an insulating film disposed on a surface of the magnetic particle;
a coil disposed in the body; and
an external electrode disposed on a first surface of the body,
wherein the magnetic particle includes a first magnetic particle that is in direct contact with the external electrode, and a second magnetic particle is free of direct contact with the external electrode, and
a region in which the first magnetic particle is distributed on the first surface is narrower than a region in which the external electrode is disposed on the first surface.

14. The coil component of claim 13, wherein at least a portion of the second magnetic particle is distributed in the region in which the external electrode is disposed on the first surface.

15. The coil component of claim 13, wherein at least a portion of the second magnetic particle protrudes further than the first surface of the body.

16. The coil component of claim 13, wherein the first magnetic particle extends to the first surface of the body, and the insulating film is not disposed on at least a portion of a surface of the first magnetic particle.

17. The coil component of claim 13, wherein
the external electrode includes a first layer and a second layer disposed on the first layer, and
the first layer includes at least one selected from the group consisting of copper (Cu) and silver (Ag).

18. The coil component of claim 16, wherein
the portion of the surface of the first magnetic particle on which the insulating film is not disposed directly contacts the external electrode.
